(19) United States
(12) Patent Application Publication
(10) Pub. No.: US 2015/0107447 A1
(43) Pub. Date: Apr. 23, 2015

(54) COMPOSITES AND BALLISTIC RESISTANT ARMOR ARTICLES CONTAINING THE COMPOSITES

(71) Applicant: E I DU Pont DE Nemours And Company, Wilmington, DE (US)

(72) Inventor: MINSHON J. CHIOU, Chesterfield, VA (US)

(73) Assignee: E I DU Pont DE Nemours And Company, Wilmington, DE (US)

(21) Appl. No.: 14/058,401

(22) Filed: Oct. 21, 2013

(51) Int. Cl. F41H 1/02; B32B 5/02; B32B 33/00; B32B 7/02; B32B 27/08; B32B 27/12; B32B 5/12; B32B 5/26

(52) U.S. Cl. CPC F41H 1/02; B32B 5/12; B32B 5/022; B32B 5/26; B32B 7/02; B32B 27/08; B32B 27/12; B32B 33/00; B32B 2250/02; B32B 2250/04; B32B 2250/20; B32B 2250/24; B32B 2255/02; B32B 2255/26; B32B 2255/10; B32B 2260/021; B32B 2260/046; B32B 2262/02; B32B 2274/00; B32B 2305/073; B32B 2305/20; B32B 2307/54; B32B 2307/558; B32B 2307/704; B32B 2307/51; B32B 2375/00; B32B 2377/00; B32B 2367/00; B32B 2571/02
USPC 89/36.02; 428/110

(57) ABSTRACT

A ballistic resistant armor article, comprises (a) a first nonwoven layer comprising a first plurality of parallel yarns, and a second nonwoven layer comprising a second plurality of parallel yarns, the yarns of the first layer having an orientation in a direction that is different from the orientation of the yarns of the second layer, (b) at least one binding yarn transverse to the plane of the first and second layers binding the first and second layers together, (c) a binding resin having a modulus no greater than 6500 psi coating at least portions of internal surfaces of the first plurality and the second plurality of yarns and (d) a viscoelastic resin coating at least portions of external surfaces of the first plurality and the second plurality of yarns, the viscoelastic resin having a modulus greater than 6500 psi.

### BACKGROUND OF THE INVENTION

1. Field of the Invention

This invention relates to composites and ballistic resistant armor articles containing the composites. The composites comprise layers of high tenacity yarns.

2. Description of Related Art

United States patent application publication number 201210024137A1 to Chiou describes a composite useful in a ballistic resistant armor article comprises a first nonwoven layer comprising a first plurality of yarns the yarns comprising a first plurality of para-aramid filaments, the first plurality of yarns arranged parallel with each other and a second nonwoven layer comprising a second plurality of yarns comprising a second plurality of para-aramid filaments, the second plurality of yarns arranged parallel with each other. The first plurality of yarns of the first layer has a yarn orientation in a direction that is different from the orientation of the second plurality of yarns in the second layer. The yarns have an elongation at break of 3.6 to 5.0 percent. The composite further comprises a thermoset or thermoplastic binding resin in the region of the interface between the two layers and a viscoelastic resin coating at least portions of external surfaces of the first and second pluralities of yarns.

U.S. Pat. No. 6,990,886 to Citterio discloses an unfinished multilayer structure used to produce a finished multilayer anti-ballistic composite. The unfinished multilayer structure includes a first layer of threads parallel with each other, superimposed, with the interpositioning of a binding layer on at least a second layer of threads which are parallel with each other. The threads of the first layer are set in various directions with respect to the threads of the second layer. The two layers are also joined by binding threads made of a thermoplastic or thermosetting material or of a material which is water-soluble or soluble in a suitable solvent.

United States patent application publication number 2011/0117351A1 to Hanks et al discloses an impact resistant composite article that has two or more layers of ballistic fabric and ionomer layers disposed between the fabric layers. The ionomer is highly neutralized so that it has essentially no melt flow. A process also for making such a composite article that involves deposition of an aqueous colloid of the ionomer onto the fabric, followed by drying.

United States patent application publication number 2011/0113534A1 to Hanks et al teaches an impact resistant composite article that has at least two or more fibrous fabric layers and a polymeric layer disposed between at least some of the fabric layers. The peel strength measured at 20° C. between the fabric layer an adjacent polymeric layer after pressing for 30 minutes at 500 psi and 160° C. is less than 1 kg/cm, and where the weight % of polymeric resin relative to the resin plus fabric is greater than 5%.

U.S. Pat. No. 4,879,165 to Smith pertains to Lightweight armor or high impact structures comprising lamina-like structures comprising zones of decreasing Young's modulus and increasing elongation characteristics. The structure contains at least one ionomer composite having aramid or linearly crystalline polyethylene fibers arranged to dissipate impact forces laterally.

There is an ongoing need to provide multilayer ballistic resistant structures for body armor of higher impact strength that will provide enhanced ballistic performance at similar or lower weight.

### BRIEF SUMMARY OF THE INVENTION

This invention is directed to a composite useful in a ballistic resistant armor article, comprising:

(a) from 75.0 to 96.0 weight percent of a first nonwoven layer comprising a first plurality of yarns comprising continuous filaments, the first plurality of yarns arranged parallel with each other,
a second nonwoven layer comprising a second plurality of yarns comprising continuous filaments, the second plurality of yarns arranged parallel with each other,
the first plurality of yarns of the first layer having an orientation in a direction that is different from the orientation of the second plurality of yarns in the second layer, wherein
the first plurality and the second plurality of yarns have a yarn tenacity of 10 to 65 grams per dtex and an elongation at break of 3.6 to 5.0 percent.

(b) at least one binding yarn binding the first and second layers together, the binding yarn being transverse to the plane of the first and second layers,
(c) from 1.0 to 7.0 weight percent of a thermoset or thermoplastic binding resin having a modulus no greater than 6500 psi positioned between the first and second nonwoven layers and coating at least portions of internal surfaces of the first plurality and the second plurality of yarns and filling some space between the filaments in the first plurality and the second plurality of yarns in the region of the interface between the two layers, and
(d) from 0.1 to 5.0 weight percent of a viscoelastic thermoplastic resin coating at least portions of external surfaces of the first plurality and the second plurality of yarns and filling some space between the filaments in the first plurality and the second plurality of yarns, the viscoelastic thermoplastic resin having a modulus greater than 6500 psi, wherein
(i) the weight percentages are expressed relative to the total weight of the composite, and
(ii) a ratio of a maximum thickness of the first or second layer to an equivalent diameter of the filaments in the first or second layer, respectively, is at least 13.

The invention is further directed to a composite of the aforesaid character comprising four nonwoven layers wherein the yarns in any one layer have an orientation that is different from the yarns in an adjacent layer.

### BRIEF SUMMARY OF THE DRAWINGS

FIG. 1 shows a plan view in perspective of a composite used to produce a ballistic resistant armor article.

FIG. 2 shows a sectional view taken at 2-2 in FIG. 1.

FIG. 3 shows a sectional view of another embodiment comprising four nonwoven layers.

### DETAILED DESCRIPTION OF THE INVENTION

The present invention is directed to a composite useful in a ballistic resistant armor article. The composite comprises a plurality of nonwoven fibrous layers, a viscoelastic thermoplastic resin, a thermoset or thermoplastic binding resin, and binding yarns.

### The Nonwoven Layers

In one embodiment the composite comprises two nonwoven layers and in a further embodiment it comprises four nonwoven layers.

The first nonwoven layer comprises a first plurality of first yarns, the yarns being arranged parallel with each other.

The second nonwoven layer comprises a second plurality of second yarns, the yarns being arranged parallel with each other.

The third nonwoven layer comprises a third plurality of third yarns, the yarns being arranged parallel with each other.

The fourth nonwoven layer comprises a fourth plurality of fourth yarns, the yarns being arranged parallel with each other.

The orientation of yarns in one layer of the composite is different from the orientation of yarns in an adjacent layer.

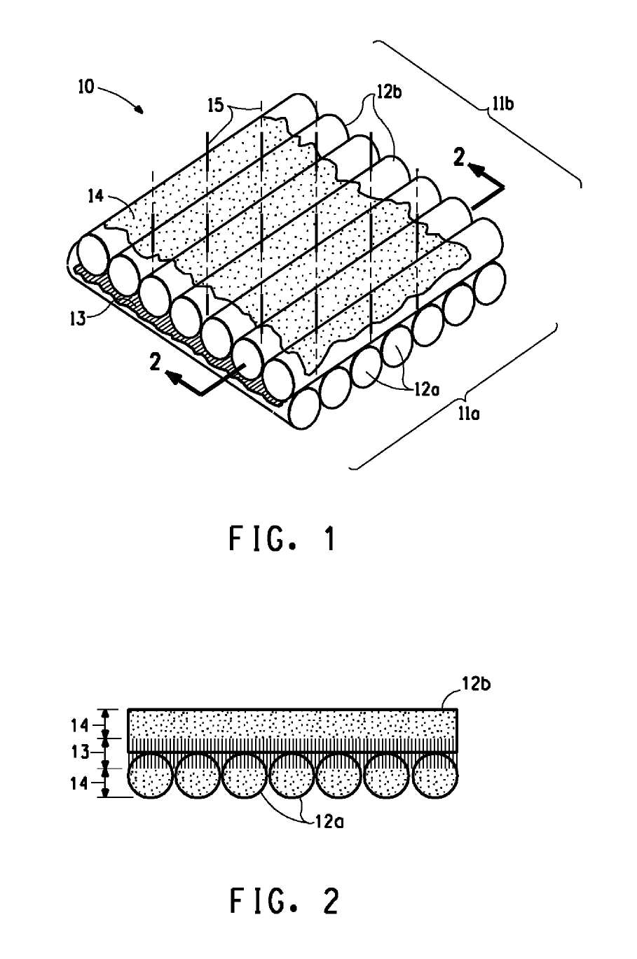

FIG. 1 shows generally at 10, a composite comprising two nonwoven layers 11a and 11b of reinforcement yarns 12a and 12b. The orientation of the first plurality of yarns 12a in the first layer 11a of the composite is different from the orientation of the second plurality of yarns 12b in the second layer 11b. As an example, the orientation of yarns in a first layer may be at zero degrees i.e. in the machine direction while the yarns in a second layer may be oriented at an angle of 90 degrees with respect to the orientation of yarns in the first layer. The machine direction is the long direction within the plane of the composite, that is, the direction in which the composite is produced. Examples of other orientation angles are +45 degrees and −45 degrees with respect to the machine direction. In a preferred embodiment the yarns in successive layers of the nonwoven composite are oriented at zero degrees and 90 degrees with respect to each other. In a four layer composite, the yarns may be oriented at angles of zero degrees, 90 degrees, zero degrees, 90 degrees respectively.

In a further embodiment the yarns in the first and second layers although being orthogonal to each other are arranged at an angle of +45 degrees and −45 degrees relative to the machine direction. Other embodiments include other cross ply angles between the yarns in adjacent layers. In some of these embodiments the yarns in adjacent layers need not be orthogonal to each other.

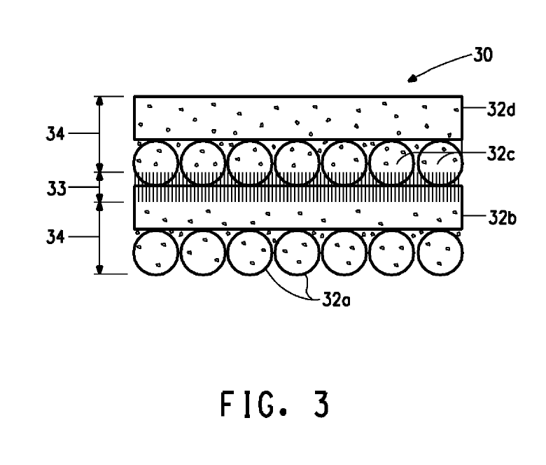

FIG. 3 shows generally at 30 a sectional view of a composite comprising four nonwoven layers of reinforcement yarns. The orientation of yarns 32a and 32c in the first and third layers respectively are in the same direction. The orientation of yarns 32b and 32d in the second and fourth layers respectively are in the same direction. In some embodiments, the orientation of the yarns in the first and third layers is orthogonal to the orientation of yarns in the second and fourth layers.

### The Yarns

Each of the first yarns comprises a first plurality of first filaments. Each of the second yarns comprises a second plurality of second filaments. Each of the third yarns comprises a third plurality of third filaments. Each of the fourth yarns comprises a fourth plurality of fourth filaments.

The first, second, third and fourth pluralities of yarns preferably have a yarn tenacity of from 10 to 65 grams per dtex and a modulus of from 400 to 3000 grams per dtex. Further, the yarns have a linear density of from 100 to 3,500 dtex and an elongation to break of from 2.0 to 5.0 percent, preferably 3.6 to 5.0 percent. In one embodiment, the yarns have a linear density of from 300 to 1800 dtex and a tenacity of from 24 to 50 grams per dtex. In still some other embodiments, the yarns have a linear density of from 100 to 1200 dtex with a range of from 400 to 1000 dtex being especially useful. In a further embodiment, the yarns have an elongation to break of from 3.6 to 4.5 percent. A finished yarn may also be made by assembling or roving together two precursor yarns of lower linear density. For example two precursor yarns each having a linear density of 850 dtex can be assembled into a finished yarn having a linear density of 1700 dtex.

Each nonwoven layer has a basis weight of from 30 to 800 g/m². In some preferred embodiments the basis weight of each layer is from 45 to 500 g/m². In some other embodiments the basis weight of each layer is from 55 to 300 g/m². In yet some other embodiments, the layers of the composite all have the same nominal basis weight.

Untwisted yarns are preferred because they offer higher ballistic resistance than twisted yarns and because they spread to a wider aspect ratio than twisted yarns, enabling more consistent fiber coverage across the layer.

The layers comprise a plurality of yarns having a plurality of continuous filaments.

In one embodiment, the yarns used in the layers form a substantially flattened array of filaments wherein individual yarn bundles are difficult to detect. In such an embodiment, the filaments are uniformly arranged in the layer, meaning there is less than a 20 percent difference in the thickness of the flattened array. The filaments from one yarn shift and fit next to adjacent yarns, forming a continuous array of filaments across the layer.

In an alternative embodiment, the yarns can be positioned such that small gaps are present between the flattened yarn bundles, or the yarns may be positioned such that the yarn bundles butt up against other bundles, while retaining an obvious yarn structure. In other embodiments, the first and the second plurality of filaments are present in the first and the second plurality of layers as substantially distinct yarns.

It is believed the use of yarns having an elongation at break of from 3.6 to 5.0 percent allows for the use of thicker layers in the composite without an appreciable loss in ballistic performance. A composite comprising at least two nonwoven layers having a ratio of the thickness of any one layer to the equivalent diameter of the filaments comprising the layer of at least 13, in conjunction with the yarns comprising the layer having an elongation to break of from 3.6% to 5.0% and a tenacity of at least 24 grams per dtex, allows a finished article to be assembled with fewer layers and yet still meet performance requirements. This offers productivity and quality improvements in the assembly process.

In some embodiments of the composite, the ratio of the thickness of any layer to the equivalent diameter of the filaments comprising the layer is at least 13, more preferably at least 16 and most preferably at least 19. By “equivalent diameter” of a filament we mean the diameter of a circle having a cross-sectional area equal to the average cross-sectional area of the filaments comprising the layer. The ratio is calculated by first determining the thickness of a layer in the composite, typically by measuring the average thickness of the final composite and dividing by the number of layers, and then dividing by the equivalent diameter of a filament used in a layer. Typically, all of the layers are of the same basis weight and all of the layers have the same filaments.

The yarns comprise from 75.0 to 96.0 weight percent based on the total weight of the composite.

### The Filaments

For purposes herein, the term “filament” is defined as a relatively flexible, macroscopically homogeneous body having a high ratio of length to width across its cross-sectional area perpendicular to its length. The filament cross section can be any shape, but is typically round or bean shaped. The yarns may also be round, bean shaped or oval in cross section. The filaments can be any length. Preferably the filaments are continuous. Multifilament yarn spun onto a bobbin in a package contains a plurality of continuous filaments. In the context of this disclosure, the terms filament and fiber may be used interchangeably.

The yarns of the present invention may be made with filaments of aromatic polyamide. A preferred aromatic polyamide is para-aramid. As used herein, the term para-aramid filaments means filaments made of para-aramid polymer. The term aramid means a polyamide wherein at least 85% of the amide (—CONH—) linkages are attached directly to two aromatic rings. Suitable aramid fibers are described in Man-Made Fibres—Science and Technology, Volume 2, in the section titled Fibre-Forming Aromatic Polyamides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

A preferred para-aramid is poly (p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether. In some preferred embodiments, the yarns of the composite consist solely of PPD-T filaments; in some preferred embodiments, the layers in the composite consist solely of PPD-T yarns; in other words, in some preferred embodiments all filaments in the composite are PPD-T filaments.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Another suitable fiber is one based on aromatic copolyamide such as is prepared by reaction of terephthaloyl chloride (TPA) with a 50/50 mole ratio of p-phenylene diamine (PPD) and 3,4′-diaminodiphenyl ether (DPE). Yet another suitable fiber is that formed by polycondensation reaction of two diamines, p-phenylene diamine and 5-amino-2-(p-aminophenyl)benzimidazole with terephthalic acid or anhydrides or acid chloride derivatives of these monomers.

When the fiber polymer is polyolefin, polyethylene or polypropylene is preferred. The term “polyethylene” means a predominantly linear polyethylene material of preferably more than one million molecular weight that may contain minor amounts of chain branching or comonomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE) or ultra-high molecular weight polyethylene (UHMWPE).

In some preferred embodiments the fibers are polyazoles. Polyazoles include polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures.

Preferred polybenzazoles are polybenzimidazoles, polybenzothiazoles, and polybenzoxazoles and more preferably such polymers that can form fibers having yarn tenacities of 30 gpd or greater. If the polybenzazole is a polybenzothioazole, preferably it is poly(p-phenylene benzobisthiazole). If the polybenzazole is a polybenzoxazole, preferably it is poly(p-phenylene benzobisoxazole) and more preferably poly(p-phenylene-2,6-benzobisoxazole) called PBO.

Preferred polypyridazoles are polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. A preferred poly(pyridobisozazole) is poly(1,4-(2,5-dihydroxyl)phenylene-2,6-pyrido[2,3-d:5,6-d′]bisimidazole which is called PIPD. Suitable polypyridazoles, including polypyridobisazoles, can be made by known procedures.

In the case of polyvinyl alcohol (PV-OH), PV-OH fibers having a weight average molecular weight of at least about 500,000, preferably at least about 750,000, more preferably between about 1,000,000 and about 4,000,000 and most preferably between about 1,500,000 and about 2,500,000 may be employed in the present invention. PV-OH fibers having a weight average molecular weight of at least about 500,000 are particularly useful in producing ballistic resistant composites. PV-OH fibers having such properties can be produced, for example, by the process disclosed in United States patent application number 569,818, filed Jan. 11, 1984, to Kwon et al.

### The Thermoset or Thermoplastic Binding Resin

The composite has a resin rich binding layer in the region of the interface between at least some of the respective nonwoven layers. Preferably the binding resin has a modulus no greater than 6500 psi. In some embodiments, the binding resin has a modulus no greater than 6500 psi, preferably less than 2000 psi. In a two layer composite the binder is in the interface region between the first nonwoven layer and the second nonwoven layer. In one embodiment of a four layer composite, the binder preferably is in the interface region between the second nonwoven layer and the third nonwoven layer. The binder resin layer is shown at 13 in FIGS. 1 and 2 and at 33 in FIG. 3. The binding layer does not fully impregnate into the yarn bundle of a nonwoven layer but coats at least portions of the internal surfaces of the yarns in each layer in the interface region between the two nonwoven layers and fills some space between the filaments within the nonwoven layer.

The resin may be a thermoset or thermoplastic material. Suitable materials for the binding layer include polyolefinic films, thermoplastic elastomeric films, polyester films, polyamide films, polyurethane films and mixtures thereof. Useful polyolefinic films include low density polyethylene films, high density polyethylene films and linear low density polyethylene films. Preferably the binding resin layer is present in the composite in an amount from 1.0 to 7.0 weight percent based on the total weight of the composite. More preferably, the binding resin layer is present in the composite in an amount from 1.0 to 5.0 weight percent based on the total weight of the composite.

In a two layer composite, the binding layer is applied by the steps of (i) forming a first nonwoven layer comprising a first plurality of yarns comprising a first plurality of continuous filaments, the first plurality of yarns arranged parallel with each other, (ii) positioning the first surface of the resin binding layer on one surface of the first nonwoven layer (iii) forming a second nonwoven layer comprising a second plurality of yarns comprising a second plurality of continuous filaments, the second plurality of yarns arranged parallel with each other and positioning the second nonwoven layer onto the second surface of the resin binding layer such that the orientation of yarns in the second nonwoven layer is in a direction that is different from the orientation of the yarns in the first nonwoven layer. The resin binding layer may be in a continuous form such as a film or in a discontinuous form such as a perforated film or a powder.

In one embodiment of a four layer composite, the binding layer is applied by the steps of (i) forming a first nonwoven layer comprising a first plurality of yarns comprising a first plurality of continuous filaments, the first plurality of yarns arranged parallel with each other, (ii) forming a second nonwoven layer comprising a second plurality of yarns comprising a second plurality of continuous filaments, the second plurality of yarns arranged parallel with each other (iii) positioning a first surface of the second nonwoven layer onto one surface of the first nonwoven layer such that the orientation of yarns in the second nonwoven layer is in a direction that is different from the orientation of the yarns in the first nonwoven layer, (iv) positioning a first surface of the resin binding layer on the second surface of the second nonwoven layer, (v) forming third nonwoven layer comprising a third plurality of yarns comprising a third plurality of continuous filaments, the third plurality of yarns arranged parallel with each other, (vi) positioning a first surface of the third nonwoven layer onto the second surface of the resin binding layer such that the orientation of yarns in the third nonwoven layer is in a direction that is different from the orientation of the yarns in the second nonwoven layer, (vii) forming a fourth nonwoven layer comprising a fourth plurality of yarns comprising a fourth plurality of continuous filaments, the fourth plurality of yarns arranged parallel with each other and, positioning the fourth nonwoven layer onto the second surface of the third nonwoven layer such that the orientation of yarns in the fourth nonwoven layer is in a direction that is different from the orientation of the yarns in the third nonwoven layer. The resin binding layer may be in a continuous form such as a film or in a discontinuous form such as a perforated film or a powder.

### The Viscoelastic Resin

The yarns of the outer surfaces of the two outer layers of the composite are coated with a viscoelastic thermoplastic resin. The resin may be applied as neat resin or via a solvent or as an aqueous dispersion. The resin coating fills some space between the filaments in the yarns in the region of the outer surfaces of the two outer nonwoven layers of the composite. This resin, which has a modulus greater than 6500 psi, is shown at 14 in FIGS. 1 and 2 and at 34 in FIG. 3. In some embodiments, the resin has a modulus of greater than 6500 psi. Preferably, the resin is a semi-crystalline polymer such as olefin-acid copolymer, polyester, polyamide or mixtures thereof. In a preferred embodiment, the resin coating does not fully impregnate the yarns. Preferably the viscoelastic resin is present in the composite in an amount from 0.1 to 5.0 weight percent based on the total weight of the composite.

An olefin-acid copolymer is also known as an ionomer. Preferably, the ionomer is an olefin acid ethylene copolymer. The ionomer may be at least 85% neutralized or 95% neutralized. In some embodiments, the ionomer may be at least 100% neutralized or greater than 100% neutralized such as greater than 110% or 120% neutralized. Neutralization refers to the level of inorganic cations that are present in the ionomer or olefin acid copolymer the high levels of neutralization lead to molten polymers with very low melt flow index (MFI) as measured at 190° or even at 200° C. Preferably, the ionomer comprises between 5 mole-percent and 15 mole-percent of acid, preferably between 8 mole-percent and 12 mole-percent of acid.

The ionomer may comprise an ethylene copolymer with an acid comonomer. Such an ethylene copolymer may be neutralized with an ion selected from the group consisting of sodium, potassium, lithium, silver, mercury, copper (I), beryllium, magnesium, calcium, strontium, barium, copper (II), cadmium, mercury, tin, lead, iron, cobalt, nickel, zinc, aluminum, scandium, iron, yttrium, titanium, zirconium, hafnium, vanadium, tantalum, tungsten, chromium, cerium, iron and combinations thereof.

The ionomer may be applied to the fabric layers in the form of a dispersion. Related are ionomer suspensions and emulsions. The dispersion may be a blend dispersion with other, non ionomeric, polymers in which the ionomer comprises at least 70% by weight of the solid content of the dispersion. The ionomer may further be applied to the fabric layers in the form of an aqueous dispersion.

The ionomer may further be plasticized or be blended with a surfactant. In one embodiment, the ionomer may comprise at least 70% by weight of the ionomer plus plasticizer or other additive, for example a surfactant. For example the plasticizer or surfactant may be a long chain fatty acid, for example 1-decanol.

Olefin-acid copolymers useful in the invention include but are not limited to ethylene-acrylic acid and ethylene methacrylic acid copolymers. The ethylene copolymer comprises 5%-25% mol percent acid comonomer, or preferably 8%-12% mol percent acid comonomer.

The ethylene copolymers utilized in the present invention can be neutralized by inorganic cations. By “degree of neutralization” is meant the mole percentage of acid groups on the ethylene copolymer that have an inorganic counterion

To produce the ionomer copolymers disclosed herein, the parent acid copolymers are neutralized at least about 85%, or preferably, at least about 95% or more preferably, at least about 100% or in excess of 100% such as 110% or 120%, based on the total number of equivalents of carboxylic acid moieties. Upon neutralization, the ionomers will have one or more metallic cations. Metallic ions that are suitable cations may be monovalent, divalent, trivalent, multivalent, or mixtures therefrom. Useful monovalent metallic ions include, but are not limited to, ions of sodium, potassium, lithium, silver, mercury, copper and the like and mixtures thereof. Useful divalent metallic ions include, but are not limited to, ions of beryllium, magnesium, calcium, strontium, barium, copper, cadmium, mercury, tin, lead, iron, cobalt, nickel, zinc and the like and mixtures therefrom. Useful trivalent metallic ions include, but are not limited to, ions of aluminum, scandium, iron, yttrium and the like and mixtures therefrom. Useful multivalent metallic ions include, but are not limited to, ions of titanium, zirconium, hafnium, vanadium, tantalum, tungsten, chromium, cerium, iron and the like and mixtures therefrom. It is noted that when the metallic ion is multivalent, complexing agents, such as stearate, oleate, salicylate, and phenolate radicals may be included, as disclosed within U.S. Pat. No. 3,404,134. The metallic ions used herein are preferably monovalent or divalent metallic ions. More preferably, the metallic ions used herein are selected from the group consisting of ions of sodium, lithium, magnesium, zinc and mixtures therefrom. Yet more preferably, the metallic ions used herein are selected from the group consisting of ions of sodium, zinc and mixtures therefrom. The parent acid copolymers of the invention may be neutralized as disclosed in U.S. Pat. No. 3,404,134.

The ionomer copolymers used herein may optionally contain other unsaturated comonomers. Specific examples of preferable unsaturated comonomers include, but are not limited to, methyl acrylate, methyl methacrylate, ethyl acrylate, ethyl methacrylate, isopropyl acrylate, isopropyl methacrylate, butyl acrylate, butyl methacrylate and mixtures thereof. In general, the ionomeric copolymers used herein may incorporate 0 to about 50 wt %, or preferably, 0 to about 30 wt %, or more preferably, 0 to about 20 wt %, of the other unsaturated comonomer(s), based on the total weight of the copolymer.

A typical process to coat or impregnate the yarns of the composite with viscoelastic resin comprises the steps of bringing the composite into contact with the resin. The resin can be in the form of a solution, emulsion, melt (neat resin) or film. When the resin is a solution, emulsion or melt, the composite can be immersed in the resin and surplus resin removed off with a doctor blade or coating roll. The resin may also be deposited onto the surface of the composite as it passes beneath a resin bath in a blade over roll coating process. The next step is to consolidate the resin impregnated composite by drying to remove the solvent or cooling to solidify the melt followed by a calendering step. The coated or impregnated composite is then rewound and cut for use in accordance with the present invention. When the viscoelastic resin is in the form of a film, the resin film is placed onto one or both surfaces of the composite and consolidated onto or into the composite by heat and pressure in a calender. The degree of resin impregnation into the fibers is controlled by the calendering conditions. The specific values for heat and pressure need to be determined for each material combination. Typically, the temperature is in the range of from 80 to 300 degrees C., preferably from 100 to 200 degrees C. and the pressure in the range of from 1 to 100 bar, preferably from 5 to 80 bar. The heat and pressure from this process also causes the binding layer resin to melt and flow to form the resin rich interface region between the respective layers of the composite. All the processes described here are well known to those skilled in the art and are further detailed in chapter 2.9 of “Manufacturing Processes for Advanced Composites” by F.C. Campbell, Elsevier, 2004.

### Binding Yarns

In some embodiments, binding threads or yarns may be present. The threads or yarns comprise a plurality of fibers (filaments). These binding yarns, shown at 15 in FIG. 1, are stitched or knitted through all the nonwoven layers from one side of the composite to the other side of the composite in a direction that is transverse (orthogonal) to the plane of the layers. This is also known as z-directional stitching. The binding yarn also stitches through the resin binding layer. Any suitable binding yarn may be used with polyester fiber, polyethylene fiber, polyamide fiber, aramid fiber, polyareneazole fiber, polypyridazole fiber, polybenzazole fiber, and mixtures thereof being particularly suited. The spacing between rows of stitches may vary depending on design requirements. The stitches may be between yarns or through yarns. In one embodiment the rows are spaced 5 mm apart.

### Uses of the Composite

A ballistic resistant armor article can be produced by combining a plurality of composites as described in the above embodiments. This invention is applicable to both soft and hard body armor. Examples of soft armor include protective apparel such as vests or jackets that protect body parts from projectiles. Examples of hard armor include helmets and protective plates for vehicles. It is preferable that the composites are positioned in the article in such a way as to maintain the offset yarn alignment throughout the finished assembly. For example, the second composite of the article is placed on top of the first composite in such a way that the orientation of the yarns comprising the bottom layer of the second composite is offset with respect to the orientation of the yarns comprising the adjacent top layer of the first composite. The actual number of composites used will vary according to the design needs of each article being made. As an example, an assembly for an antiballistic vest pack typically has a total areal density of between 3.5 to 7.0 kg/m². Thus the number of composites will be selected to meet this weight target with the number typically being from 5 to 25. For hard armor vehicle plates the number of composites would be the amount required to form a cured pressed plate having a thickness of about 15 mm. Thus the number of composites will be selected to meet the weight and thickness target with the number typically being from 20 to 100. For helmets, the cured plate thickness is from about 6 mm to 13 mm. Other components such as foam may also be incorporated into the armor article.

### TEST METHODS

The following test methods were used in the following Examples.

Linear Density: The linear density of a yarn or fiber was determined by weighing a known length of the yarn or fiber based on the procedures described in ASTM D1907-97 and D885-98. Decitex or “dtex” is defined as the weight, in grams, of 10,000 meters of the yarn or fiber. Denier (d) is 9/10 times the decitex (dtex).

Yarn Mechanical Properties: The yarns to be tested were conditioned and then tensile tested based on the procedures described in ASTM D885-98. Tenacity (breaking tenacity), modulus of elasticity and elongation to break were determined by breaking yarns on an Instron® universal test machine.

Areal Density: The areal density of a nonwoven layer was determined by measuring the weight of a 10 cm×10 cm sample of the layer. The areal density of the final article was the weight of a 10 cm×10 cm sample of the article.

Ballistic Penetration Performance: A statistical measure of ballistic performance is V₅₀ which is the average velocity at which a bullet or a fragment penetrates the armor equipment in 50% of the shots, versus non penetration of the other 50% of the shots. The parameter is measured at a zero degree angle of obliquity of the projectile path to the target. Resistance to a 16-grain fragment was tested per MIL-STD-662F

Layer Thickness and Equivalent Filament Diameter can be determined by standard electron microscopy techniques.

### EXAMPLES

The following examples are given to illustrate the invention and should not be interpreted as limiting it in any way.

In all examples, the yarn used in the woven and nonwoven fabrics was 660 dtex Kevlar® KM2 p-aramid yarn, available from E.I. du Pont de Nemours and Company, Wilmington, Del. The yarn had a nominal tenacity of 25.9 g/dtex.

In all examples, ballistic testing of the panel was conducted according to MIL-STD-662F testing protocol using 16 grain fragment projectiles.

### Comparative Example A

In Comparative Example A, the ballistic resistant article comprised a stack of composites, each composite being a plain weave woven fabric coated with an ionomer. The fabric had 11.4 ends/cm in both warp and weft directions and had a nominal areal weight of 157 gsm. The viscoelastic ionomeric resin had a nominal coat weight of 17 g/m² and was coated onto one of the external surfaces of the woven fabric. The resin was Michem 2960 (Michelman Co., Ohio), a dispersion of ethylene-acrylic acid (E-AA) copolymer (10 mole % AA comonomer) in inonomer form. The nominal modulus of the viscoelastic resin was 6800 psi.

Fifty-six 40 cm×40 cm sheets of the coated woven fabrics were pressed together into a hard rigid panel under 500 tons pressure at 320 degrees F. for 900 seconds. The total weight of the panel was 9.75 kg. Result of the ballistic tests gave an average V50 value of 854 m/s.

### Comparative Example B

In this example, the ballistic resistant article comprised a stack of composites, each composite being an ionomer coated nonwoven fabric each fabric comprising first and second layers of unidirectionally aligned para-aramid yarns in a +45°/−45° configuration relative to each other. The first yarn layer comprised a first plurality of yarns and the second yarn layer comprised a second plurality of yarns. A thermoplastic binding layer of polyurethane resin film having a nominal areal weight of 30 g/m² and a resin modulus of about 700 psi was positioned between each of the first and second unidirectional yarn layers adhering to at least portions of the internal surfaces of the first plurality and the second plurality of yarns and filling some space between the filaments in the first plurality and the second plurality of yarns in the center region of the composite. Polyester threads of 140 denier were used as binding yarn stitching in a transverse direction through the plane of the first and second unidirectional yarn layers. The nonwoven composite also comprised a viscoelastic liquid polymer resin of polyisobutene coating of about 35 g/m² forms at least portions of external surfaces of the first plurality and the second plurality of yarns in regions remote from the interface of the two layers of the composite. The nonwoven composite had a nominal weight of 334 g/m².

Twenty-nine 40 cm×40 cm sheets of non-woven composite were pressed together under 500 tons pressure at 320 degrees F. for 900 seconds into a hard rigid panel. The total weight of the panel was 9.69 kg/m². Result of the ballistic tests gave an average V50 value of 828 m/s.

### Example 1

In Example 1, the article of this invention comprised a stack of ionomer coated nonwoven fabrics. Each nonwoven fabric comprised first and second layers of unidirectionally aligned para-aramid yarns in a +45°/−45° configuration relative to each other. The first yarn layer comprised a first plurality of yarns and the second yarn layer comprised a second plurality of yarns. A thermoplastic binding layer of polyurethane resin film having a nominal areal weight of 15 g/m² and a nominal resin modulus of 700 psi was positioned between each of the first and second unidirectional yarn layers adhering to at least portions of the internal surfaces of the first plurality and the second plurality of yarns and also filling some space between the filaments in the first plurality and the second plurality of yarns in the center region of the composite. Polyester threads of 140 denier were used as binding yarn stitching in a transverse direction through the plane of the first and second unidirectional yarn layers. A viscoelastic resin coating of about 10 g/m² of the Michem 2960 ionomeric resin of Comparative Example A was coated onto one external side of the fabric. The nominal modulus of the viscoelastic resin was 6800 psi. The nonwoven fabric-resin composite had a nominal weight of 280 g/m².

Thirty-five 40 cm×40 cm sheets of nonwoven composite were pressed together under 500 tons pressure at 320 degrees F. for 900 seconds into a hard panel. The total weight of the panel was 9.78 kg/m².

Result of the ballistic tests gave an average V50 value of 920 m/s, which showed about an 8% improvement over Comparative Example A (same coating resin but different fabric form) and a 12% improvement over Comparative Example 2 (same fabric form but different coating resin).

What is claimed is:

1. A composite useful in a ballistic resistant armor article, comprising:
(a) from 75.0 to 96.0 weight percent of
a first nonwoven layer comprising a first plurality of yarns comprising continuous filaments, the first plurality of yarns arranged parallel with each other,
a second nonwoven layer comprising a second plurality of yarns comprising continuous filaments, the second plurality of yarns arranged parallel with each other,
the first plurality of yarns of the first layer having an orientation in a direction that is different from the orientation of the second plurality of yarns in the second layer, wherein
the first plurality and the second plurality of yarns have a yarn tenacity of 10 to 65 grams per dtex and an elongation at break of 3.6 to 5.0 percent.
(b) at least one binding yarn binding the first and second layers together, the binding yarn being transverse to the plane of the first and second layers,
(c) from 1.0 to 7.0 weight percent of a thermoset or thermoplastic binding resin having a modulus no greater than 6500 psi positioned between the first and second nonwoven layers and coating at least portions of internal surfaces of the first plurality and the second plurality of yarns and filling some space between the filaments in the first plurality and the second plurality of yarns in the region of the interface between the two layers, and
(d) from 0.1 to 5.0 weight percent of a viscoelastic thermoplastic resin coating at least portions of external surfaces of the first plurality and the second plurality of yarns and filling some space between the filaments in the first plurality and the second plurality of yarns, the viscoelastic thermoplastic resin having a modulus greater than 6500 psi,
wherein
(i) the weight percentages are expressed relative to the total weight of the composite, and
(ii) a ratio of a maximum thickness of the first or second layer to an equivalent diameter of the filaments in the first or second layer, respectively, is at least 13.

2. The composite of claim 1, wherein the binding resin has a modulus of no greater than 2000 psi.

3. The composite of claim 1, wherein the second plurality of yarns in the second layer is oriented orthogonally to the first plurality of yarns in the first layer.

4. The composite of claim 1, wherein the first and the second plurality of filaments are present in the first and the second plurality of layers as substantially distinct yarns.

5. The composite of claim 1, wherein the viscoelastic thermoplastic resin is a semi-crystalline polymer.

6. The composite of claim 1, wherein the first and second plurality of yarns of the first and second layers, respectively, have a tenacity of 20 to 40 grams per dtex.

7. The composite of claim 1, wherein the first and second plurality of yarns of the first and second layers, respectively, have an elongation at break of 3.6 to 4.5 percent.

8. The composite of claim 1, wherein the modulus of elasticity of the first and second plurality of yarns is from 100 to 3500 grams per dtex.

9. The composite of claim 1, wherein the thermoplastic binding resin is polyurethane.

10. The composite of claim 1, wherein the binding resin comprises from 1.0 to 5.0 weight percent of the composite.

11. The composite of claim 1 wherein the viscoelastic resin comprises from 0.1 to 4.0 weight percent of the composite.

12. The composite of claim 1, wherein the at least one binding yarn comprises a plurality of filaments wherein the filaments are polyester filaments, polyethylene filaments, polyamide filaments, aramid filaments, polyareneazole filaments, polypyridazole filaments, polybenzazole filaments, or mixtures thereof.

13. The composite of claim 1, wherein the first and second pluralities of yarns comprise a polymer of aromatic polyamide, aromatic copolyamide, ultra-high-molecular-weight polyolefin, polyvinylalcohol, polyazole or combinations thereof.

14. The composite of claim 5, wherein the semi-crystalline polymer is an olefin acid copolymer, polyester, polyamide or mixtures thereof.

15. The composite of claim 11 wherein the viscoelastic thermoplastic resin comprises from 0.1 to 3.0 weight percent of the composite.

16. The composite of claim 13 wherein the aromatic polyamide is p-aramid.

17. The composite of claim 14 wherein the ethylene-acrylic acid copolymer is neutralized with an ion selected from the group consisting of sodium, potassium, lithium, silver, mercury, copper (I), beryllium, magnesium, calcium, strontium, barium, copper (II), cadmium, mercury, tin, lead, iron, cobalt, nickel, zinc, aluminum, scandium, iron, yttrium, titanium, zirconium, hafnium, vanadium, tantalum, tungsten, chromium, cerium, iron and combinations thereof.

18. A composite useful in a ballistic resistant armor article, comprising:
(a) from 75.0 to 96.0 weight percent of
a first nonwoven layer comprising a first plurality of yarns comprising continuous filaments, the first plurality of yarns arranged parallel with each other,
a second nonwoven layer comprising a second plurality of yarns comprising continuous filaments, the second plurality of yarns arranged parallel with each other,
a third nonwoven layer comprising a third plurality of yarns comprising continuous filaments, the third plurality of yarns arranged parallel with each other,
a fourth nonwoven layer comprising a fourth plurality of yarns comprising continuous filaments, the fourth plurality of yarns arranged parallel with each other,
the second plurality of yarns of the second layer having an orientation in a direction that is different from the orientation of the first plurality of yarns in the first layer and the third plurality of yarns in the third layer,
the fourth plurality of yarns of the fourth layer having an orientation in a direction that is different from the orientation of the third plurality of yarns in the third layer and
the first, second, third and fourth pluralities of yarns have a yarn tenacity of 10 to 65 grams per dtex and an elongation at break of 3.6 to 5.0 percent.
(b) at least one binding yarn binding the first, second, third and fourth layers together, the binding yarn being transverse to the plane of the first, second, third and fourth layers
(c) from 1.0 to 7.0 weight percent of a thermoset or thermoplastic binding resin having a modulus no greater than 6500 psi positioned between the second and third yarn layers and coating at least portions of internal surfaces of the second and third pluralities of yarns and filling some space between the filaments of the second or third pluralities of yarns in the region of the interfaces between the yarn layers, and
(d) from 0.1 to 5.0 weight percent of a viscoelastic resin coating at least portions of external surfaces of the first plurality and the fourth plurality of yarns and filling some space between the filaments in the first plurality and the fourth plurality of yarns, the viscoelastic resin having a modulus greater than 6500 psi,
wherein
(i) the weight percentages are expressed relative to the total weight of the composite,
(ii) a ratio of a maximum thickness of the first, second, third or fourth layer to an equivalent diameter of the filaments in the first, second, third or fourth layer, respectively, is at least 13.

19. A ballistic resistant armor article, comprising a plurality of the composites of claim 1 or claim 18.

20. The use of the article of claim 19 as a component in hard or soft body armor.
